(19) United States
(12) Patent Application Publication
(10) Pub. No.: US 2010/0018911 A1
(43) Pub. Date: Jan. 28, 2010

(54) Water Distribution Manifold Assembly

(76) Inventor: Thomas L. VanZeeland, Cary, NC (US)

Correspondence Address: COATS & BENNETT, PLLC, 1400 Crescent Green, Suite 300, Cary, NC, 27518, US

(21) Appl. No.: 12/505,105

(22) Filed: Jul. 17, 2009

Related U.S. Application Data
(60) Provisional application No. 61/082,916, filed on Jul. 23, 2008.

(51) Int. Cl. B01D 35/02; B01D 35/157; B01D 35/01; B01D 29/60; B01D 35/26; B01D 29/00; B01D 29/92; B01D 35/14

(52) U.S. Cl. 210/86; 210/417; 210/137; 210/90; 210/240; 210/410; 210/87; 210/435; 210/418

(57) ABSTRACT

The teachings presented herein provide a water distribution manifold assembly for distribution of water for mixed indoor and outdoor usage. The assembly finds direct application in water reclamation and conservation in that it allows for the use of runoff and gray water. The assembly integrates in-line filtration in a convenient, readily accessible way. In one or more embodiments, the assembly includes: a supply inlet and an associated check valve and pressure release valve; a filter unit connected to a second check valve; a pressure gauge; one or more outlets, each of which may be connected to a check valve; and a manifold or connecting pipe that interconnects the inlet, filter unit, and one or more outlets. The assembly also may include a controller, which in one or more embodiments provides control, monitoring, and communications for the assembly and/or associated water distribution systems.

### RELATED APPLICATIONS

This application claims priority from the U.S. provisional patent application filed on 23 Jul. 2008 and assigned Application No. 61/082,916, and which is incorporated herein by reference.

### FIELD OF THE INVENTION

The present invention generally relates to water reclamation and distribution, and particularly relates to a water distribution manifold assembly that is advantageous for water collection and distribution, such as used for rainwater harvesting, gray water reclamation, etc.

### BACKGROUND

Water conservation has long been of interest in at least some locales, but that interest is now much more widespread. The broadened interest arises from the recognition that clean water is one of our more precious natural resources. Water conservation efforts implicate any number of lifestyle changes, and many such changes are laudable. However, even without significantly altering the overall amount of water we use, meaningful reductions in the amount of water drawn from potable water sources, such as municipal water systems, can be realized through the effective use of alternate water sources. Key examples include water collection and distribution systems that rely at least partially on rainwater, runoff water, and gray water (drain water).

For example, the United States Green Building Council (USGB) promulgates the Leadership in Energy and Environmental Design (LEED) green building certification system, which prominently considers the water efficiency of buildings, given the recognition that buildings represent major consumers of the potable water supply. LEED certification requirements consider a number of mechanisms for improving the water efficiency of buildings, including rainwater harvesting.

Such systems are known. For example, U.S. Pat. No. 6,941,702 to Abrams et al. discloses a rainwater collecting and dispensing system. The '702 system uses a collecting tank to capture rainwater from gutters, and a number of distribution lines to send that water to various end devices, such as toilets, sprinklers, etc. In at least one embodiment, the tank is elevated and water head is used to provide pressurized flow from the tank.

In a somewhat more sophisticated example, U.S. Pat. No. 6,663,769 to Hosoya discloses a container placed under house eaves to collect rainwater. The rainwater is piped via a valve-based connection into an initial precipitation collection tank. That tank can be bypassed after it is full, for example, with rainwater then routed to a purifier that provides water to a storage tank. The purifier includes one or more tanks or reservoirs for chemically treating the collected water. The '769 patent further discloses a pump and a downstream filter, for obtaining pressurized, filtered outflow from the storage tank.

Some of these systems target outdoor water use, e.g. the '702 patent to Abrams, while others target indoor use. See, for example, U.S. Pat. No. 5,234,286 to Wagner, which discloses supplying potable water systems. Still further, at least some water harvesting systems disclose the use of so called water distribution manifolds. For example, see U.S. Pat. No. 6,553,723 to Alcorn, and U.S. Pat. No. 7,207,748 to Urban. However, while use of manifolds in one form or another has been disclosed, these disclosed manifolds are more or less purpose built for the context in which they are presented. Consequently, it is difficult to plan and implement water collection and harvesting systems built around a readily available manifold assembly that offers an integrated set of features directly supporting a broad range of water collection distribution system designs and configurations.

### SUMMARY

The teachings presented herein provide a water distribution manifold assembly for distribution of water for mixed indoor and outdoor usage. The assembly finds direct application in water reclamation and conservation in that it allows for the use of runoff and gray water. The assembly integrates in-line filtration in a convenient, readily accessible way.

In one or more embodiments, the assembly includes a supply inlet and an associated check valve and pressure release valve; a filter unit connected to a second check valve; a pressure gauge; one or more outlets, each of which may be connected to a check valve; and a manifold or connecting pipe that interconnects the inlet, filter unit, and one or more outlets. One or more embodiments of the manifold further include a controller. The controller is configured to perform one or more of the following functions: manifold assembly control (e.g., valve control), manifold assembly monitoring (e.g., pressure, flow), additional water distribution system monitoring and/or control (e.g., supply reservoir monitoring, inlet pump/pressure control), and communication/interface support (e.g., provide local display information and/or interface to a computer or other network for remote data inspection, control, etc.).

In at least one embodiment, a water distribution manifold assembly as contemplated herein comprises an interconnecting pipe having an inlet portion and an outlet portion, a water inlet coupled to the inlet portion of the interconnecting pipe, for inletting water into the interconnecting pipe, and a filter unit in fluid communication between the water inlet and outlet portions of the interconnecting pipe, for filtering inlet water from the water inlet and providing filtered water to the outlet portion of the interconnecting pipe. The assembly further comprises an indoor water outlet coupled to the outlet portion of the interconnecting pipe, for providing filtered water for indoor use, where the indoor water outlet is fitted with a plumbing adaptor for coupling to an indoor plumbing system. Still further, the assembly includes an outdoor water outlet coupled to the outlet portion of the interconnecting pipe, for providing filtered water for outdoor water use.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a perspective view demonstrating one exemplary embodiment of the assembly.

FIG. 2 is a block diagram of one exemplary embodiment of the assembly within a water distribution system.

### DETAILED DESCRIPTION

With further reference to the drawings, one embodiment of the water distribution manifold assembly of the present invention is shown therein and indicated generally by the number 10. As will be appreciated from other portions of the disclosure, the water distribution manifold assembly 10 is configured for use in homes, business, or other structures within or around which a water source is required.

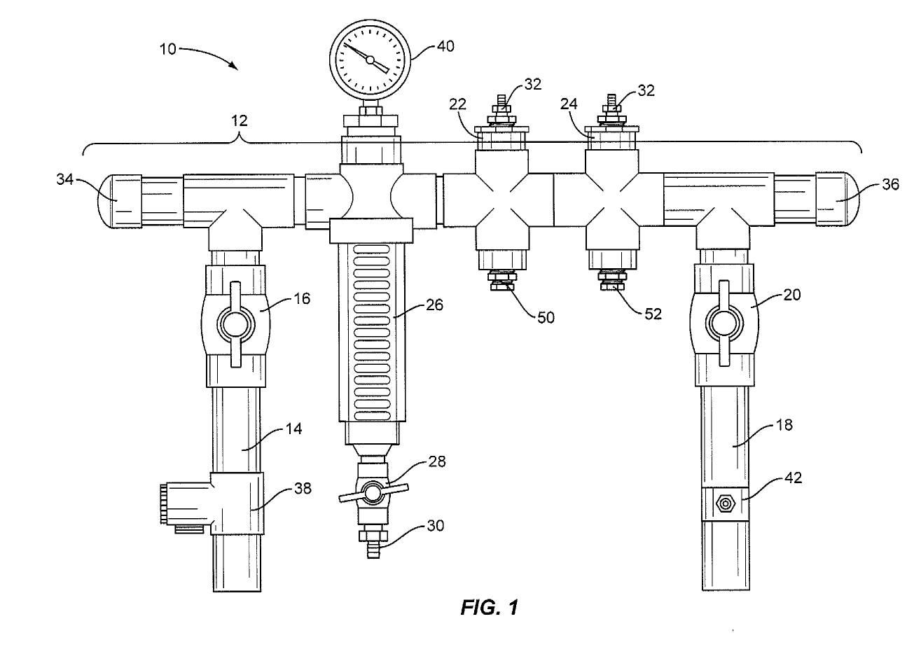

By way of non-limiting example, FIG. 1 illustrates one embodiment of the water distribution manifold assembly 10, which may be constructed, for example, from plastic, copper, galvanized steel, etc. The water distribution manifold assembly 10 includes an interconnecting or manifold pipe 12, which may be pieced together or continuous, and which acts as the overall manifold body for interconnecting the various other elements of the manifold assembly 10. In the illustration, these other elements include an inlet 14 and an associated inlet valve 16, an irrigation outlet 18 and an associated outlet valve 20, along with one or more additional outlets (e.g., outlets 22, 24), and a filter unit 26.

In at least one embodiment, the filter unit 26 includes a purge valve 28 and purge outlet 30, for removing collected particulates, etc. In the illustrated configuration, all depicted outlets (18, 22, and 24) are downstream from the filter unit 26, thus providing filtered water to these outlets. Such a configuration may be advantageous where it is desired to draw only filtered water from the assembly's outlets. For example, one or both of the outlets 22 and 24 may be particularly configured for interconnecting with interior plumbing, e.g., one or both outlets may be configured with male or female adaptors 32 for ready coupling to interior plumbing lines.

The manifold assembly 10 as illustrated is also shown with end caps 34 and 36, which provide for convenient expansion of the manifold assembly 10. End cap 34 may be removed and the manifold pipe 12 may be expanded at that end to allow for outlets of unfiltered water. Similarly, end cap 36 may be removed to allow for additional outlets of the filtered water.

The particular implementation of the filter unit 26 may vary, depending upon the intended use of the manifold assembly 10. One implementation contemplated herein comprises a filter rated at a minimum of 51 microns, which uses centrifugal force to separate particulate matter from the water. This filter also includes a purge system such that the filter could be cleaned without removing it from the manifold assembly 10. However, those skilled in the art will appreciate that a variety of filters may be used in the filter unit 26, and it is not limited to this exemplary embodiment. Further, those skilled in the art will appreciate that the manifold assembly 10 in one or more embodiments is configured with one or more outlets in advance of the filter unit 26. Such configurations provide filtered and unfiltered flows from the manifold assembly 10. Of course, a given water distribution system may, in any case, provide filtering in advance of the inlet 14.

The manifold assembly 10 as illustrated in FIG. 1 further depicts additional elements, which may be advantageous in certain implementations but may be omitted according to the particular application at hand. These additional elements include a pressure release valve 38, pressure gauge 40, and female air pressure fitting 42. The manifold assembly 10 optionally includes the pressure release valve 38 as a safety feature to prevent water within the manifold assembly 10 from exceeding design limits. The pressure release valve 38 may, as shown, be a separate part connecting the inlet 14 to a length of pipe. Alternatively, the pressure release valve 38 may be integrated within the inlet 14. The manifold assembly 10 may additionally or alternatively comprise a pressure gauge 40 connected to the manifold pipe 12. The pressure gauge 40 would allow the user to monitor the water pressure within the manifold pipe 12. The manifold assembly 10 may also additionally or alternatively comprise a pressure fitting 42 connected to or incorporated into irrigation outlet 18. The pressure fitting 42 may be used for the purging or winterizing of outdoor pipes/plumbing connected to the irrigation outlet, such as a connected irrigation system or other outdoor water system.

Still further, FIG. 1 illustrates that the manifold assembly 10 may include one or more ports (e.g., 50, 52), for control and/or monitoring. These ports may simply be outlets, allowing interconnection with a range of external devices, or they may be plumbed with fittings particularly adapted for interface with control/monitoring elements. As an example, one or more of these control/monitoring ports may be terminated with a pressure transducer or other sensing element.

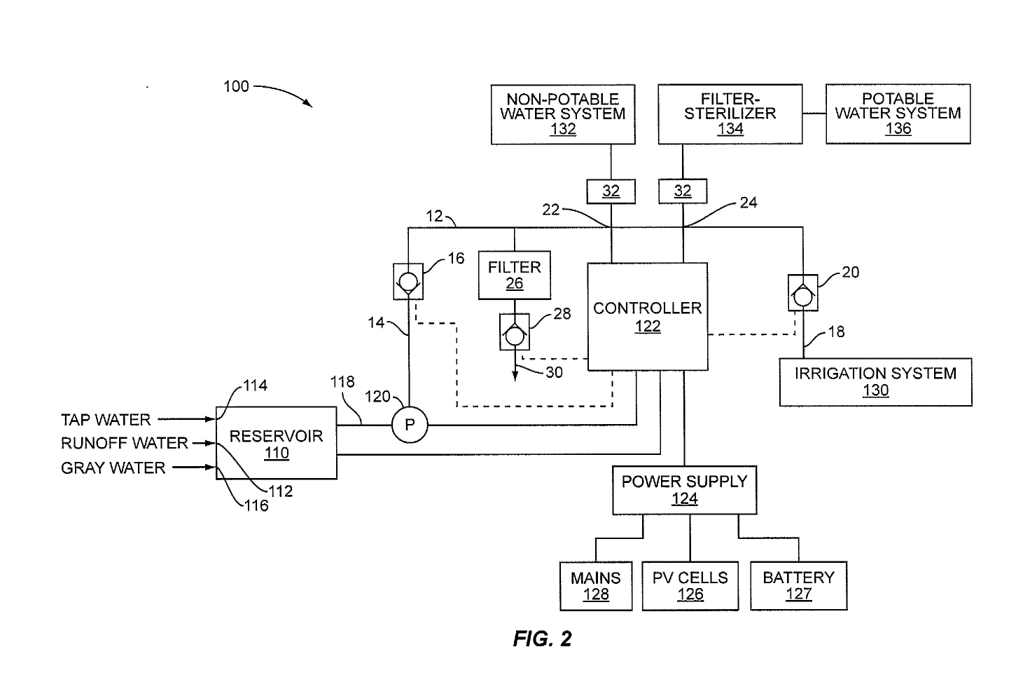

With the above features in mind, those skilled in the art will appreciate that the manifold assembly 10 finds advantageous use in a variety of water distribution systems. By way of non-limiting example, FIG. 2 illustrates an embodiment of the manifold assembly 10 within an example water collection and distribution system 100.

The illustrated system 100 comprises a reservoir 110, which has one or more sources of water. Generally, these sources may include a water harvesting system for capturing runoff water (e.g., rainwater) and a water reclamation system for collecting gray water (e.g., drain water from household use). Although not shown, one or more embodiments of the distribution system 100 may include more than one reservoir 110.

Thus, in one or more embodiments, the reservoir 110 draws runoff water from a runoff water collection system at a runoff supply line 112. This runoff water collection system may collect water from a variety of sources, to include, for example, from a waterproof liner under a deck. The reservoir 110 may also be connected to secondary water sources and have a gray water supply line 116. The reservoir 110 may also have a tap water supply line 114 for use during set up and maintenance or as a back up when the supply of runoff water or gray water is not able to meet the user's demands. The tap water supply line 114 may acquire water from a public water supply, a well or other reliable source of water. Runoff and gray water may be filtered through filters prior to entering the reservoir 110. The water contained in reservoir 110 may be additionally or alternatively filtered upon being drawn out of reservoir 110 and prior to entering an intake pipe 118.

As noted before, the manifold assembly 10 includes or is associated with a controller, e.g., the controller 122 depicted in FIG. 2. The controller may, for example, be sold with and specially configured for use with the various elements of the manifold assembly 10. In any case, in one or more embodiments, the controller 122 provides various monitoring and control functions.

For example, the controller 122 may be configured to monitor the water level within the reservoir 110. The controller 122 may further include a management system to control the drawing of water from secondary sources, such as tap water or gray water, when the water level in the reservoir 110 reaches a certain critical level. This critical level may be pre-set or may be set by the user.

In one or more embodiments, the controller 122 includes or is associated with one or more transducers for monitoring flow and pressure. In particular, the controller 122 may interface with transducers for monitoring flow and pressure within the manifold assembly 10. The controller 122 may further comprise a digital display for displaying readouts or other indications of flow and pressure within the manifold assembly 10 (and/or elsewhere within the system 100). The controller 122 may also further comprise indicator lights reflecting the status of the pressure and flow of water within the manifold assembly 10 (and/or elsewhere within the system 100).

The controller 122 may also provide for overall system control and/or monitoring, and thus may interface with one or more pumps (reservoir pumps), irrigation system controllers, flow control valves, filtering systems, rain detectors, etc. Further, the controller 122 may include one or more communication and/or signaling interfaces, allowing for remote monitoring and/or control. For example, the controller 122 may include an Ethernet port and/or 802.11 b/g/n interface or one or more other types of interface circuits or ports for interfacing to a control network. The controller 122 also may include various control/monitoring inputs and outputs, such as relay I/O, analog I/O (e.g., current loops), digital I/O, etc.

Broadly, those skilled in the art will appreciate that the controller 122 may be implemented in a variety of ways and should not be limited to those embodiments described herein. For example, the controller 122 may comprise a microprocessor-based circuit. A microcontroller implementation, wherein a single-chip controller incorporates a processor core, along with supporting memory, input/output ports, timers, and A/D and D/A converters, is particularly advantageous but non-limiting. In at least one embodiment, then, computer program instructions in the form of firmware and/or software are stored in memory (e.g., FLASH, EEPROM, etc.) and executed by a microprocessor within the controller 122 for implementation of the control and monitoring methods described herein. Those skilled in the art will appreciate, however, that the controller 122 can be implemented using other programmable devices, such as FPGAs, CPLDs, and various ASIC devices. Simpler implementations also complement the use of discrete control circuitry.

Regardless of such details, various options are contemplated herein for providing electricity to controller 122. In one or more exemplary embodiments, a power supply 124 may be powered by photovoltaic cells 126 (along with a charge storage battery). The power supply 124 may additionally or alternatively be powered by a mains electricity supply 128 or battery 127. While such solar-powered implementations may be particularly advantageous for some installations, it will be understood that wind power or other renewable energy sources may be used additionally or alternatively, to power the controller 122, possibly along with other elements (pumps, valves, etc.) in a water collection and distribution system 100 that integrates the manifold assembly 10.

In general, significant flexibility exists with respect to configuring power supply systems and, indeed, with respect to configuration of the overall water collection and distribution system 100. On that latter point, in the illustrated embodiment, a pump 120 connects the intake pipe 118 to the inlet 14 of the manifold assembly 10. In one exemplary embodiment, the controller 122 may have a hardwire connection to the pump 120. By controlling the pump 120, the controller 122 manages the pressure and flow of water from the intake pipe 118 to the inlet 14. Water flowing into the inlet 14 passes through the inlet valve 16, which also may be monitored and managed by controller 122, and into the interconnecting pipe 12. The water then passes through the filter unit 26. Collected sediment is discharged from the filter unit 26 through the purge outlet 30, as controlled by the purge valve 28. The controller 122 may be configured to monitor and/or control the purge valve 28.

After passing through the filter unit 26, the filtered water flows through the interconnecting pipe 12 and out of the water distribution manifold assembly 10, through any one or more of its outlets. The filtered water may be discharged through the irrigation outlet 18 (also referred to as an outdoor water outlet) and into an irrigation system 130 or other outdoor water application (pool, fountain, etc.), subject to operation of the outlet valve 20.

Of course, water alternatively or additionally flows through one or more of the additional outlets 22 and 24, which, as noted may be fitted with plumbing adaptors 32 for ready connection to indoor plumbing. As such, these outlets may be referred to as indoor water outlets. While not explicitly illustrated, the outlets 22 and 24 may include or otherwise be associated with valves for outflow control. The controller 122 may monitor and/or control such valves. Of course, these and other valves may additionally or alternatively be manually controlled, and a user of the system can preset the path of water flow through the distribution manifold manually or via the controller 122. Flow also can be managed dynamically by the controller 122 in at least some embodiments.

With their advantageous interfacing to interior plumbing, water flowing from the outlets 22, for example, may enter at least a non-potable water system 132. Such water may be used for flushing toilets, washing laundry, or filling pools. As a further example, water from outlet 24 may flow into a filtration and sterilization system 134. The filtration and sterilization system 134 provides filtration and sterilization to a potable water standard. The filtered/sterilized water thus may flow into a potable water supply 136. Of course, additional system elements, such as pressure regulators, flow control elements (check valves), etc., may be included as needed or desired.

Also, those skilled in the art will appreciate that the present invention may, of course, be carried out in other ways than those herein set forth without departing from the scope and the essential characteristics of the invention. The present embodiments are therefore to be construed in all aspects as illustrative and not restrictive.

What is claimed is:

1. A water distribution manifold assembly comprising:
an interconnecting pipe having an inlet portion and an outlet portion;
a water inlet coupled to the inlet portion of the interconnecting pipe, for inletting water into the interconnecting pipe;
a filter unit in fluid communication between the water inlet and outlet portions of the interconnecting pipe, for filtering inlet water from the water inlet and providing filtered water to the outlet portion of the interconnecting pipe;
an indoor water outlet coupled to the outlet portion of the interconnecting pipe, for providing filtered water for indoor use, said indoor water outlet fitted with a plumbing adaptor for coupling to an indoor plumbing system; and
an outdoor water outlet coupled to the outlet portion of the interconnecting pipe, for providing filtered water for outdoor water use.

2. The water distribution manifold assembly of claim 1, further comprising an outlet valve integrated into or otherwise coupled with the outdoor water outlet, for controlling water flow from the outdoor water outlet.

3. The water distribution manifold assembly of claim 1, further comprising an inlet valve integrated into or otherwise coupled with the water inlet, for controlling water flow into the water inlet.

4. The water distribution manifold assembly of claim 1, further comprising a pressurized air fitting integrated into or otherwise coupled with the outdoor water outlet, downstream from said outlet valve, for use in purging an outdoor plumbing system supplied by the outdoor water outlet.

5. The water distribution manifold assembly of claim 1, wherein the water distribution manifold assembly comprises a pressurized water distribution manifold assembly, wherein the water inlet is configured to receive a pressured flow of inlet water, and wherein the indoor and outdoor water outlets are configured to provide pressurized flows of outlet water.

6. The water distribution manifold assembly of claim 5, further comprising a pressure gauge integrated in or otherwise coupled to the interconnecting pipe, and configured to measure a fluid pressure in the interconnecting pipe.

7. The water distribution manifold assembly of claim 5, further comprising a pressure release valve integrated in or otherwise coupled to the interconnecting pipe, and configured to limit a maximum fluid pressure that is permitted to develop within the interconnecting pipe.

8. The water distribution manifold assembly of claim 1, further comprising a removable end cap at one or both ends of the interconnecting pipe, to provide for extending a length of the inlet portion of the interconnecting pipe length, extending a length of the outlet portion of the interconnecting pipe, or both.

9. The water distribution manifold assembly of claim 1, further comprising one or more unfiltered water outlets coupled to the inlet portion of the interconnecting pipe.

10. The water distribution manifold assembly of claim 1, wherein the filter unit includes a purge valve and an associated purge outlet, for purging sediment from the filter unit.

11. The water distribution manifold assembly of claim 1, wherein the filter unit includes a filter rated at a minimum particle size of about 51 microns.

12. The water distribution manifold assembly of claim 1, further comprising a controller that is configured to perform at least one of the following: valve control for the water distribution manifold assembly; pressure or flow monitoring for the water distribution manifold assembly; valve or pump control for one or more water systems that supply or are supplied by the water distribution manifold assembly; and electronic communications for control or monitoring of the water distribution manifold assembly.

13. The water distribution manifold assembly of claim 12, wherein said water distribution manifold assembly includes one or more controllable valves configured to control water flow into or out of the water distribution manifold assembly, and wherein the controller is operatively coupled to the one or more controllable valves, and is configured to control the one or more control valves.

14. The water distribution manifold assembly of claim 13, wherein the controller controls the one or more control valves responsive to at least one of the following: monitoring water pressure or flow rate for the water distribution manifold assembly; and receiving valve control signaling through a communication interface of the controller.

15. The water distribution manifold assembly of claim 12, wherein the controller includes a pump control output that is configured to provide a pump control signal for controlling an external water pump associated with providing pressurized water flow into the water inlet of the interconnecting pipe, and wherein the controller is configured to generate or otherwise control the pump control signal as a function of monitoring water flow in the interconnecting pipe, or water pressure in the interconnecting pipe, or both.

16. The water distribution manifold assembly of claim 12, wherein the water distribution manifold assembly includes one or more sensor elements configured to provide one or more sensor signals to the controller, and wherein the controller is configured to monitor the one or more sensing signals and provide at least one of a visual indication associated with the sensing signals, and a communication signaling output associated with the sensing signals.

17. The water distribution manifold assembly of claim 12, wherein the water distribution manifold further includes a solar or wind power system that is configured to provide operating power to the controller.

18. The water distribution manifold assembly of claim 12, wherein the controller is configured to monitor a water level within a reservoir serving as a water source for the water distribution manifold, and wherein the controller is configured to control the drawing of water from a secondary source into the reservoir in response to detecting a critical water level in the reservoir.

19. The water distribution manifold assembly of claim 1, wherein the water distribution manifold includes at least one of a flow rate sensor and a pressure sensor, and wherein the water distribution manifold includes one or more displays that are configured to display at least one of: an indication of water flow rate in the interconnecting pipe, an indication of water pressure in the interconnecting pipe, and an indication of water level in a supply tank used to supply water to the water distribution manifold assembly.

20. The water distribution manifold assembly of claim 1, wherein the water distribution manifold assembly comprises a pressure-regulated water distribution manifold assembly that is configured to regulate water pressure with respect to one or more water outlets by at least one of: controlling a supply pump that provides pressured water flow to the water inlet, and controlling a pressure regulator in or associated with the interconnecting pipe.
